(19) United States
(12) Patent Application Publication
(10) Pub. No.: US 2007/0122646 A1
(43) Pub. Date: May 31, 2007

(54) SOLDER COMPOSITION AND SOLDERING STRUCTURE

(76) Inventors: Cheng-Yi Liu, Taoyuan (TW); Shen-Jie Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,447

(22) Filed: Feb. 8, 2006

(30) Foreign Application Priority Data
Nov. 28, 2005 (TW) 94141666

(51) Int. Cl. C22C 13/00; B32B 15/01

(52) U.S. Cl. 428/646; 420/557

(57) ABSTRACT

A solder composition for reacting with aluminum is provided. The main alloying components in the solder includes tin (Sn), zinc (Zn) and chromium (Cr) with 0.01 wt % to 20 wt % zinc and 0.01 wt % to 20 wt % chromium.

### CROSS-REFERENCE TO RELATED APPLICATION

This application claims the priority benefit of Taiwan application serial no. 94141666, filed on Nov. 28, 2005. All disclosure of the Taiwan application is incorporated herein by reference.

### BACKGROUND OF THE INVENTION

1. Field of the Invention

The present invention relates to a solder composition. More particularly, the present invention relates to a solder composition and soldering structure applied to aluminum.

2. Description of the Related Art

Solder is a metallic substance mainly used for joining two identical metallic materials or two different metallic materials structurally together at a relative low temperature. Because soldering techniques can provide an electronic package with a high conductivity, a high heat-dissipating capacity and a high bonding reliability, soldering material has been widely adopted for assembling various electronic components and packaging semiconductor devices.

Most conventional soldering material has tin (Sn) as its main component and other metallic elements as secondary components to form a binary or multi-nary alloy, for example, tin-lead (Sn—Pb) alloy, tin-silver (Sn—Ag) alloy, tin-indium (Sn—In) alloy and tin-sliver-copper (Sn—Ag—Cu) alloy. The foregoing soldering materials are now used in vast quantities for joining together some ‘solderable’ metallic objects. At present, the heat dissipating fins or heat dissipating substrates are often fabricated using aluminum in many types of heat dissipating modules. In advanced semiconductor production processes, aluminum wires are frequently used as a means for transmitting signals or connecting power source in active devices or passive devices. However, aluminum is hardly bonded with the aforementioned tin-based conventional soldering material. Thus, before using the soldering material, a metallic pad layer must be coated on the ‘non-solderable’ metal first. In general, the metallic pad layer includes an adhesive layer such as a titanium layer or a chromium layer and a ‘solderable’ metallic layer such as a copper layer or a nickel layer. Nevertheless, the processing complexity and the production cost will be increased.

In addition, flux is often applied to remove the oxide material on the surface of the metallic pad layer and increase wettability before performing a conventional reflow process. Yet, the application of the flux not only increases uncertainties and complexities in the production process, but also the structural strength of the bond may be deteriorated due to residual flux and voids generated thereby.

### SUMMARY OF THE INVENTION

Accordingly, at least one objective of the present invention is to provide a solder composition suitable for reacting with aluminum to form stronger bonds.

Another objective of the present invention is to provide a soldering structure capable of increasing structural strength.

To achieve these and other advantages and in accordance with the purpose of the invention, as embodied and broadly described herein, the invention provides a solder composition that mainly comprises 0.01˜20 wt % of zinc and 0.01˜20 wt % of chromium. The remaining ingredients include at least tin and unavoidable impurity.

The present invention also provides a soldering structure that includes an aluminum substrate and a solder composition disposed thereon. The solder composition mainly comprises 0.01˜20 wt % of zinc and 0.01˜20 wt % of chromium. The remaining ingredients include at least tin and unavoidable impurity.

The present invention also provides an alternative soldering structure that includes an aluminum substrate, a chromium layer and a solder composition. The chromium layer is disposed on the aluminum substrate and the solder composition is disposed on the chromium layer. The solder composition mainly comprises 0.01˜20 wt % of zinc. The remaining ingredients include at least some and unavoidable impurity.

The present invention also provides another soldering structure that includes an aluminum substrate, a zinc layer and a solder composition. The zinc layer is disposed on the aluminum substrate and the solder composition is disposed on the zinc layer. The solder composition mainly comprises 0.01˜20 wt % of chromium. The remaining ingredients include at least tin and unavoidable impurity.

In one embodiment of the present invention, the solder composition further includes bismuth (Bi), indium (In) or a mixture thereof.

In one embodiment of the present invention, the solder composition further includes the elements of the IVB group, the elements of the VB group or a mixture thereof having an amount of 0.01˜10 wt. %. Furthermore, the IVB group includes at least titanium (Ti), zirconium (Zr), hafnium (Hf) or a combination thereof. In addition, the VB group includes at least vanadium (V), niobium (Nb), tantalum (Ta) or a combination thereof.

In one embodiment of the present invention, the solder composition further includes the elements of the IIIB group, or a mixture thereof having an amount of 0.01˜10 wt %. The IIIB group includes at least the lanthanide series, the actinide series, or a combination thereof. The IIIB group includes at least samarium (Sm), neodymium (Nd), lutetium (Lu) or a combination thereof. The lanthanide series includes at least cerium (Ce), praseodymium (Pr), neodymium (Nd), gadolinium (Gd), ytterbium (Yb) or a combination thereof.

In one embodiment of the present invention, the solder composition further includes silver (Ag), copper (Cu) or a mixture thereof having an amount 0.01˜10 wt %.

In one embodiment of the present invention, the solder composition further includes 0.01˜10 wt % of antimony (Sb).

In one embodiment of the present invention, the solder composition further includes nickel (Ni), cobalt (Co), manganese (Mn) or a mixture thereof having an amount 0.01˜10 wt %.

In one embodiment of the present invention, the solder composition further includes 0.01˜10 wt % of gallium (Ga).

In one embodiment of the present invention, the soldering structure further includes an oxidation-resistant layer disposed over the aluminum substrate and located between the solder composition and the aluminum substrate. In addition, the material of the oxidation-resistant layer can be gold (Au) or platinum (Pt).

In one embodiment of the present invention, the soldering structure further includes an oxidation-resistant layer disposed over the chromium layer and located between the solder composition and the chromium layer. In addition, the material of the oxidation-resistant layer can be gold or platinum.

In one embodiment of the present invention, the soldering structure further includes an oxidation-resistant layer disposed over the zinc layer and located between the solder composition and the zinc layer. In addition, the material of the oxidation-resistant layer can be gold or platinum.

Accordingly, the solder in present invention includes zinc, chromium and a base material of tin. Because chromium has a greater affinity with oxygen, the chromium can easily bond with the oxygen atoms in the oxygen layer on glass, metal or semiconductor substrate. In addition, zinc has a high solubility in aluminum. Hence, an alloy of zinc-aluminum (Zn—Al) solid solution can easily form at their interface. Therefore, the solder composition can increase its wettability in most materials and lower the surface energy between the solder composition in the melted state and the substrate material.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a soldering structure according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

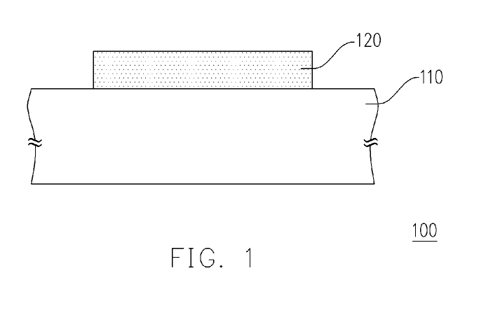

FIG. 1 is a soldering structure according to one embodiment of the present invention. As shown in FIG. 1, the soldering structure 100 in the present embodiment includes an aluminum substrate 110 and a solder composition 120. The solder composition 120 is disposed on the aluminum substrate 100. Furthermore, the solder composition 120 is suitable for reacting with the aluminum substrate 110. In addition, the aluminum substrate 110 can be an aluminum (Al) pad or an aluminum (Al) wire. The solder composition 120 mainly includes 0.01˜20 wt % of zinc (Zn), 0.01˜20 wt % of chromium (Cr). The remaining percentage of the material in the solder composition 120 includes at least tin and unavoidable impurity.

If the properties of the solder composition 120 need to be changed, the solder composition 120 in present embodiment may include other ingredients. For example, the solder composition 120 may include the bismuth (Bi), indium (In) or a mixture thereof. In another embodiment, the solder composition 120 may further include the elements of the IVB group, the elements of the VB group or a mixture thereof having an amount of 0.01˜10 wt. %. The IVB group includes at least titanium, zirconium, hafnium or a combination thereof. The VB group includes at least vanadium, niobium, tantalum, or a combination thereof.

In another embodiment, the solder composition 120 further includes the elements of the IIIB group or a mixture thereof having an amount of 0.01˜10 wt %. The IIIB group includes lanthanide series, the actinide series or a combination thereof. For example, the IIIB group includes at least samarium, neodymium, lutetium or a combination thereof. The lanthanide group of elements includes at least cerium, praseodymium, neodymium, gadolinium, ytterbium or a combination thereof.

In another embodiment, the solder composition 120 further includes silver, copper or a mixture thereof having an amount 0.01˜10 wt %. More specifically, the silver in the solder composition 120 can lower the surface tension and the soldering temperature of the solder composition 120 in the melted state and increase the bonding strength of the final bond. Furthermore, the copper in the solder composition 120 can increase the wettability of the solder composition 120 so that the soldering strength of the final bond will be increased.

In another embodiment, the solder composition 120 further includes 0.01˜10 wt % of antimony. Furthermore, the solder composition 120 includes nickel, cobalt, manganese or a mixture thereof having an amount 0.01˜10 wt %. In addition to change the bonding temperature of the solder composition 120, the aforementioned antimony, nickel, cobalt and manganese can also increase the wettablity of the solder composition 120 and the bonding strength of the solder joint.

In another embodiment, the solder composition 120 further includes 0.01˜10 wt % of gallium. More specifically, the gallium can assist the removal of the oxide layer on the bonding material (for example, the aluminum substrate 110) and lower the bonding temperature.

The bonding temperature of the solder composition 120 in the present invention is roughly between 100° C.˜550° C. In addition, the solder composition 120 in the present invention can be directly applied to the surface of the bonding substrate just like glue without the application of any flux.

More specifically, when the solder composition 120 has been heat to melt, the affinity with oxygen of the chromium (Cr) in the solder composition 120 will cause the chromium to congregate on the surface of the solder material. The chromium will react with the oxide material and the oxide layer on the bonding material. Then, the zinc inside the solder composition 120 will react with the aluminum substrate 110 to form an alloy of zinc-aluminum (Zn—Al) solid solution at their interface. The method of melting the solid composition 120 includes plate heating, hot air heating, ultrasonic heating, resistor heating, electromagnetic heating and so on. The bonding strength provided by the solder composition 120 in the present invention is described in detail below.

TABLE 1

| | Example 1 | | Example 2 | Example 3 | Example 4 | |
|---|---|---|---|---|---|---|
| Prior Technique | 48.5 | kgf | 32.3 kgf | 33.3 kgf | 53 | kfg |
| Embodiment | 54 | kgf | 53.5 kgf | 40.4 kgf | 43.4 | kgf |

Table 1 is a tabulation of the results of tests carried out using the experimental equipment 1220WS provided by the DELTA ELECTRONICS. The straining speed is 2 mm/min, the loading range of the measurement is 100kg, the length of travel is 10 mm, the bonding area is 64 mm², and the experimental condition is copper-aluminum bonding. In solder material used in the prior technique experiment is supplied by the S-Bond company and has a Model No. 220-50. The composition of the solder material in the prior technique experiment includes 10 wt % of chromium (Cr), 5 wt % of zinc (Zn) and roughly 85 wt % of tin (Sn). According to the aforementioned experimental results, the embodiment has an average bonding strength better than the prior technique. It should be noted that although only a single solder composition and its experimental data are disclosed in the present embodiment, this solder composition should not be used to limit the scope of the present invention. Similar experimental testing on the other solder composition disclosed in the present embodiment can also be carried out by technicians familiar with such experimental technique to find out the increase in average bonding strength of the solder composition relative to the prior technique. Thus, to simplify the explanations, a detailed description of the experimental results of the other solder compositions is omitted here.

The solder composition 120 in the present invention utilizes chromium (Cr) as the main activate component. Due to the affinity of chromium with oxygen, the chromium can easily combine with the oxygen atom on the surface of aluminum to form a chromium-oxygen (Cr—O) bond. Meanwhile, due to the high solubility of zinc in aluminum, zinc can react with aluminum to form a solid solution alloy at their interface. In addition, the solder composition 120 can easily bond with non-solderable metal such as aluminum without the application flux. Furthermore, the solder composition in the present invention has a better coating capability and a rapid oxidation of the soldering surface will be improved.

It should be noted that the zinc and chromium in the aforementioned soldering structure 100 does not have to come from the solder composition 120. For example, when a layer of zinc (not shown) is coated over the aluminum substrate 110, zinc can be excluded from the solder composition 120. In addition, a layer of oxidation resistant material (not shown), such as gold (Au) or platinum (Pt) can also be formed over the zinc layer. Similarly, when a layer of chromium (not shown) is coated on the aluminum substrate 110, chromium can be excluded from the solder composition 120, and a layer of oxidation resistant material (not shown) can be formed over the chromium layer. Furthermore, a layer of oxidation resistant material (not shown) can also be directly formed over the aluminum substrate 110. The solder composition 120 is disposed on the oxidation-resistant layer thereafter.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A solder composition suitable for reacting with aluminum, the solder composition comprising:
0.01˜20 wt % of zinc;
0.01˜20 wt % of chromium;
the remaining percentage of at least tin; and
unavoidable impurity.

2. The solder composition of claim 1, further includes bismuth, indium or a mixture thereof.

3. The solder composition of claim 1, further includes from the elements of the IVB group, the elements of the VB group or a mixture thereof having an amount of 0.01˜10 wt. %.

4. The solder composition of claim 3, wherein the IVB group includes at least titanium, zirconium, hafnium or a combination thereof.

5. The solder composition of claim 3, wherein the VB group includes at least vanadium, niobium, tantalum or a combination thereof.

6. The solder composition of claim 1, further includes the elements of the IIIB group or a mixture thereof having an amount of 0.01˜10 wt %.

7. The solder composition of claim 6, wherein the IIIB group includes at least lanthanide series, the actinide series or a combination thereof.

8. The solder composition of claim 7, wherein the lanthanide series includes at least cerium, praseodymium, neodymium, gadolinium, ytterbium or a combination thereof.

9. The solder composition of claim 7, wherein the IIIB group includes at least samarium, neodymium, lutetium or a combination thereof.

10. The solder composition of claim 1, further includes silver, copper or a mixture thereof having an amount 0.01˜10 wt %.

11. The solder composition of claim 1, further includes 0.01˜10 wt % of antimony.

12. The solder composition of claim 1, further includes nickel, cobalt, manganese, or a mixture thereof having an amount 0.01˜10 wt %.

13. The solder composition of claim 1, further includes 0.01˜10 wt % of gallium.

14. A soldering structure, comprising:
an aluminum substrate;
a solder composition, disposed on the aluminum substrate, the solder composition includes:
0.01˜20 wt % of zinc;
0.01˜20 wt % of chromium;
the remaining percentage of at least tin; and
unavoidable impurity.

15. The soldering structure of claim 14, wherein the solder composition further includes bismuth, indium or a mixture thereof.

16. The soldering structure of claim 14, wherein the solder composition further includes the elements of the IVB group, the elements of the VB group or a mixture thereof having an amount of 0.01˜10 wt. %.

17. The soldering structure of claim 16, wherein the IVB group includes at least titanium, zirconium, hafnium or a combination thereof.

18. The soldering structure of claim 16, wherein the VB group includes at least vanadium, niobium, tantalum or a combination thereof.

19. The soldering structure of claim 14, wherein the solder composition further includes the elements of the IIIB group or a mixture thereof having an amount of 0.01˜10 wt %.

20. The soldering structure of claim 19, wherein the IIIB group includes at least lanthanide series, actinide series or a combination thereof.

21. The soldering structure of claim 19, wherein the lanthanide series includes at least cerium, praseodymium, neodymium, gadolinium, ytterbium or a combination thereof.

22. The soldering structure of claim 19, wherein the IIIB group includes at least samarium, neodymium, lutetium or a combination thereof.

23. The soldering structure of claim 14, wherein the solder composition further includes silver, copper or a mixture thereof having an amount 0.01˜10 wt %.

24. The soldering structure of claim 14, wherein the solder composition further includes 0.01˜10 wt % of antimony.

25. The soldering structure of claim 14, wherein the solder composition further includes nickel, cobalt, manganese or a mixture thereof having an amount 0.01˜10 wt %.

26. The soldering structure of claim 14, wherein the solder composition further includes 0.01˜10 wt % of gallium.

27. The soldering structure of claim 14, further includes an oxidation-resistant layer disposed over the aluminum substrate and located between the solder composition and the aluminum substrate.

28. The soldering structure of claim 27, wherein the material constituting the oxidation-resistant layer includes gold or platinum.

29. A soldering structure, comprising:
an aluminum substrate;
a chromium layer disposed on the aluminum substrate;
a solder composition disposed on the chromium layer, the solder composition includes:
0.01˜20 wt % of zinc;
the remaining percentage of at least tin; and
unavoidable impurity.

30. The soldering structure of claim 29, wherein the solder composition further includes bismuth, indium or a mixture thereof.

31. The soldering structure of claim 29, wherein the solder composition further includes the elements of the IVB group, the elements of the VB group or a mixture thereof having an amount of 0.01˜10 wt. %.

32. The soldering structure of claim 30, wherein the IVB group includes at least titanium, zirconium, hafnium or a combination thereof.

33. The soldering structure of claim 31, wherein the VB group includes at least vanadium, niobium, tantalum or a combination thereof.

34. The soldering structure of claim 29, wherein the solder composition further includes the elements of the IIIB group or a mixture thereof having an amount of 0.01˜10 wt %.

35. The soldering structure of claim 34, wherein the IIIB group includes at least lanthanide series, actinide series or a combination thereof.

36. The soldering structure of claim 34, wherein the lanthanide series includes at least cerium, praseodymium, neodymium, gadolinium, ytterbium or a combination thereof.

37. The soldering structure of claim 34, wherein the IIIB group includes at least samarium, neodymium, lutetium and a combination thereof.

38. The soldering structure of claim 29, wherein the solder composition further includes silver, copper or a mixture thereof having an amount 0.01˜10 wt %.

39. The soldering structure of claim 29, wherein the solder composition further includes 0.01˜10 wt % of antimony.

40. The soldering structure of claim 29, wherein the solder composition further includes nickel, cobalt, manganese and a mixture thereof having an amount 0.01˜10 wt %.

41. The soldering structure of claim 29, wherein the solder composition further includes 0.01˜10 wt % of gallium.

42. The soldering structure of claim 29, further includes an oxidation-resistant layer disposed over the chromium layer and located between the solder composition and the chromium layer.

43. The soldering structure of claim 42, wherein the material constituting the oxidation-resistant layer includes gold or platinum.

44. A soldering structure, comprising:
an aluminum substrate;
a zinc layer disposed on the aluminum substrate;
a solder composition disposed on the zinc layer, the solder composition includes:
0.01˜20 wt % of chromium;
the remaining percentage of at least tin; and
unavoidable impurity.

45. The soldering structure of claim 44, wherein the solder composition further includes bismuth, indium or a mixture thereof.

46. The soldering structure of claim 44, wherein the solder composition further includes the elements of the IVB group, the elements of the VB group or a mixture thereof having an amount of 0.01˜10 wt. %.

47. The soldering structure of claim 46, wherein the VB group includes at least titanium, zirconium, hafnium or a combination thereof.

48. The soldering structure of claim 46, wherein the VB group includes at least vanadium, niobium, tantalum or a combination thereof.

49. The soldering structure of claim 44, wherein the solder composition further includes the elements of the IIIB group or a mixture thereof having an amount of 0.01˜10 wt %.

50. The soldering structure of claim 49, wherein the IIIB group of elements includes lanthanide series, actinide series or a combination thereof.

51. The soldering structure of claim 49, wherein the lanthanide series includes at least cerium, praseodymium, neodymium, gadolinium, ytterbium or a combination thereof.

52. The soldering structure of claim 49, wherein the IIIB group includes at least samarium, neodymium, lutetium or a combination thereof.

53. The soldering structure of claim 44, wherein the solder composition further includes silver, copper or a mixture thereof having an amount 0.01˜10 wt %.

54. The soldering structure of claim 44, wherein the solder composition further includes 0.01˜10 wt % of antimony.

55. The soldering structure of claim 44, wherein the solder composition further includes nickel, cobalt, manganese or a mixture thereof having an amount 0.01˜10 wt %.

56. The soldering structure of claim 44, wherein the solder composition further includes 0.01˜10 wt % of gallium.

57. The soldering structure of claim 44, further includes an oxidation-resistant layer disposed over the chromium layer and located between the solder composition and the zinc layer.

58. The soldering structure of claim 57, wherein the material constituting the oxidation-resistant layer includes gold or platinum.
